(19) United States
(12) Patent Application Publication
(10) Pub. No.: US 2005/0016351 A1
(43) Pub. Date: Jan. 27, 2005

(54) Holder for tip and method for manufacturing the same, and scribing device and manual cutter that are provided with the holder for tip

(76) Inventor: Hiroshi Tomimori, Suita-city (JP)

Correspondence Address: WENDEROTH, LIND & PONACK, L.L.P., 2033 K STREET N. W., SUITE 800, WASHINGTON, DC, 20006-1021, US

(21) Appl. No.: 10/497,968

(22) PCT Filed: Dec. 18, 2002
(86) PCT No.: PCT/JP02/13234

(30) Foreign Application Priority Data
Dec. 18, 2001 (JP) 2001-384231

(51) Int. Cl. B26F 3/00

(52) U.S. Cl. 83/880; 83/698.41; 225/1

(57) ABSTRACT

A chip holder has a cutter chip having a conical shaft at both sides thereof. Concaves for supporting the cutter chip are bell-shaped having a curve with a predetermined radius of curvature. In an example, solid lubricant may be supplied from the outside of the holder to the concave of the chip holder. Thus the life of the cutter chip can be extended.

### TECHNICAL FIELD

This invention relates to a chip holder with a cutter chip, its fabrication method, a scribing apparatus and a manual cutter therewith.

### BACKGROUND ART

A chip holder, having a cutter chip at the lower end thereof, is employed to scribe a line on a surface of a plate made of a brittle material for separating the plate into pieces. FIG. 1 shows examples of prior art cutter chips 2 disclosed in Japanese Utility Model Publication 62-023779/1987. As shown in (a) in FIG. 1, the cutter chip 2 has a shape having two cones sharing a common base, and two peaks thereof are used as a shaft of the cutter chip 2. Further, as shown in (b), (c) and (d) in FIG. 1, the cutter chips 2 may have concave gradients, convex gradients and R-chamfered peaks. The cutter chip 2 may be made of sintered diamond. In the chip holder, friction of the chip against bearings used to support the chip becomes low, and the life for scribing of the chip is extended.

Recently, for liquid crystal panels and the like fabricated by using a scribing process, it is highly demanded to decrease the price of an end product, and it is requested to decrease the cost for scribing and to increase the efficiency of scribing further. As to a chip holder, it is needed to increase the life of chip holder for scribing.

### DISCLOSURE OF INVENTION

An object of the invention is to provide a chip holder having a higher scribing efficiency and a longer scribing life.

A chip holder according to the invention includes a cutter chip having a conical shaft at both sides of a circular ridge line of a cutting edge thereof, two holders; and two bearings for holding the cutter chip, provided at opposing sides of the two holders. Each of the two bearings has a bell-shaped concave for supporting the cutter chip.

Preferably, the bell-shaped concave has a curved plane having a predetermined radius of curvature.

Preferably, the bell-shaped concave is not through to the holder.

Preferably, the bell-shaped concave is not through to the holder, and the radius of curvature is 0.1D to D wherein diameter of cutting edge of the cutter chip is represented as D.

Preferably, the bell-shaped concave is extended to the holder.

Preferably, the bell-shaped concave is extended to the holder, and the radius of curvature is D to 2D wherein diameter of cutting edge of the cutter chip is represented as D.

Preferably, the bearings are made of monocrystalline diamond.

Preferably, the bearings are made of sintered diamond.

In a method according to the invention for producing a chip holder having a cutter chip having a conical shaft at both sides of a circular ridge line of a cutting edge thereof, a bell-shaped concave is formed at a bearing for supporting the cutter chip, a bearing holder holding the bearing are mounted into each of first and second holder members, and a cutter chip is combined with the first and second holder members having the bearings.

Preferably, the bearing is made of monocrystalline diamond.

Preferably, the concave with the bell shape is fabricated with a YAG laser.

Preferably, the bearing is made of sintered diamond.

Preferably, the bell-shaped concave is formed with electric discharging machining.

A scriber apparatus according to the invention includes a mechanism for moving a scribing head in X and/or Y direction relatively to a table on which a plate made of a brittle material is put. The scribing head provides one of the chip holders mentioned above.

A manual cutter according to the invention has a cylindrical grip, and a chip holder fixed to an end of the grip. The chip holder is one of the chip holders mentioned above.

An advantage of the invention is that the life of the cutter chip and the chip holder can be extended because the precision of rotation of the cutter chip is improved and the friction resistance at the bearings can be decreased by supplying solid lubricant according to the structure of the chip holder having chip holders with recesses to support a cutter chip of a shape of two cones sharing a common base, each of the recesses having a concave with a predetermined radius of curvature.

### BRIEF DESCRIPTION OF DRAWINGS

FIG. 1 is a plan view of prior art cutter chips to be held by a holder;

FIG. 2 is an enlarged, schematic view of a chip holder in a region around a chip and a bearing therefor;

FIG. 3 is a diagram of a prior art wire-drawer around a dice thereof;

FIG. 4 is a diagram for a front view and a side view of a chip holder;

FIG. 5 is an enlarged, schematic view of a chip holder in a region around a chip and a bearing therefor according to a first embodiment;

FIG. 6 is an enlarged, schematic view of an example of a chip holder in a region around a chip and a bearing therefor according to a second embodiment;

FIG. 7 is an enlarged, schematic view of an example of a chip holder in a region around a chip and a bearing therefor according to a third embodiment;

FIG. 8 is a diagram on fabrication steps of a bearing for the chip holder according to the third embodiment;

FIG. 9 is a front view of a scribing apparatus with the chip holder according to the invention;

FIG. 10 is a side view of the scribing apparatus shown in FIG. 9; and

FIG. 11 is a partial sectional view of a manual cutter with a chip holder according to the invention.

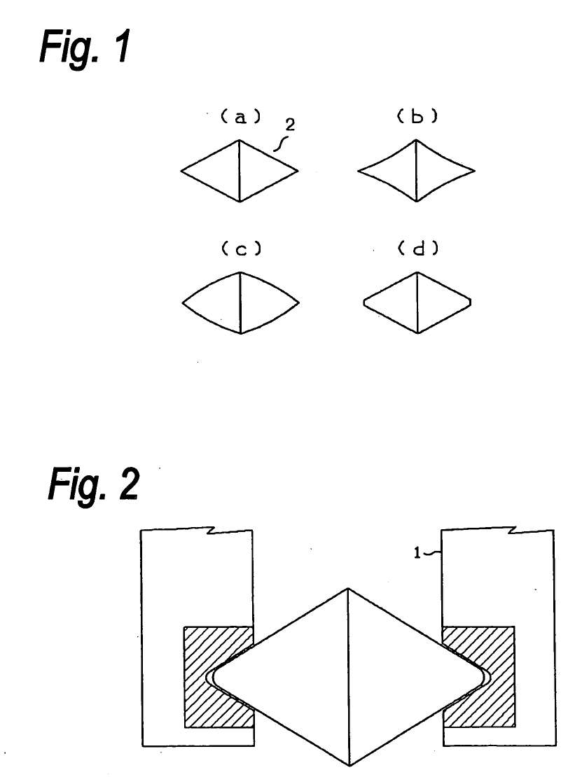

### BEST MODE FOR CARRYING OUT THE INVENTION

Referring now to the drawings, wherein like reference characters designate like or corresponding parts throughout the several views, embodiments of the invention are explained below.

The inventors studied prior art chip holders in order to improve fabrication efficiency and for extending the life thereof for scribing. FIG. 2 shows an example of a prior art cutter chip 2 and bearings 3a of a holder 1 for the chip 2 in detail. The bearings 3a support the cutter chip 2 at two sides thereof. They are made of sintered diamond. A supporting section 3b to be in contact with the cutter chip 2 has a conical concave to abut along the contour of the cutter chip 2. Based on a test on the life of the cutting edge of the cutter chip 2, in order to extend the life of the cutting edge of a cutter chip 2, it is found more effective to decrease friction resistance between the cutter chip 2 and the supporting section 3b to improve the precision on the rotation of the cutter chip 2, rather than to prevent wear and tear of the cutting edge of the cutter chip 2. That is, it is desirable to improve the precision on the rotation of the cutter chip 2 to decrease the wear of the shaft of the cutter chip 2 and of the bearings 3a.

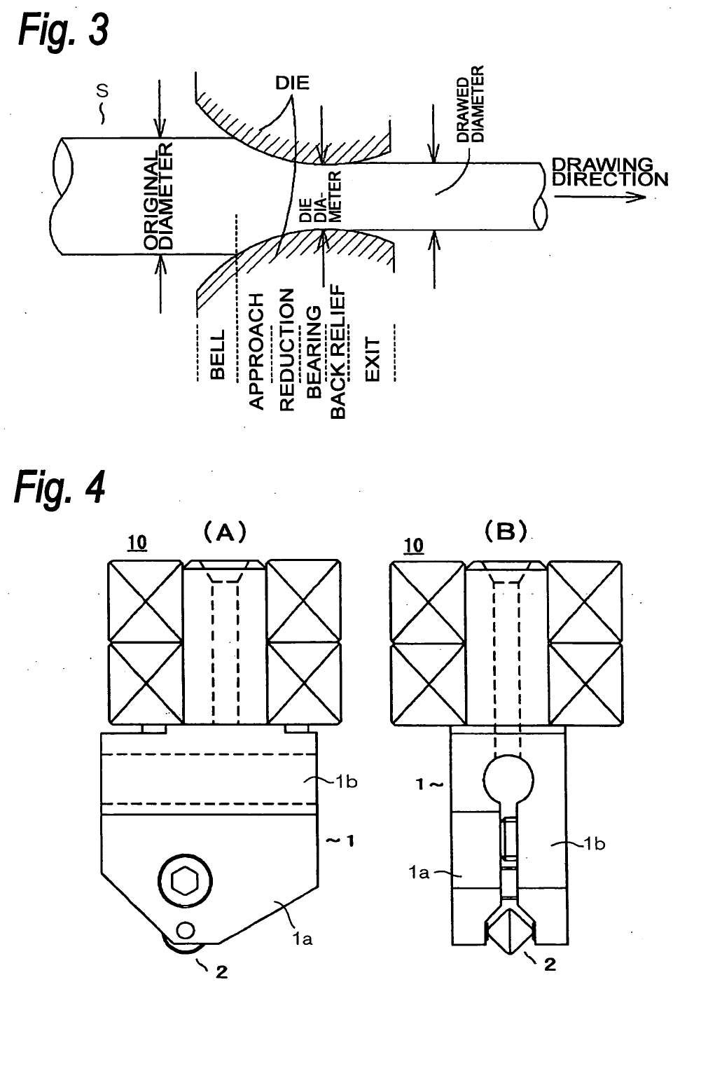

FIG. 3 shows a die of a withdrawing machine for drawing a wire S in order to decrease its diameter. The die has regions called as bell (entrance), approach, reduction, bearing, back relief and exit. It is made of diamond by taking the life thereof and the precision of drawing into account. The inner area of the die for drawing has a shape appropriate for the precision of the drawing, wear resistance and high strength, and its section has a gradual curve.

The inventors find that when the supporting section 3b of a chip holder has a bell shape curve as shown in FIG. 3 instead of the conical shape curve shown in FIG. 2, the resulting stable linear contact of the cutter chip 2 at the supporting section 3b improves centrality and rotation precision of the cutter chip. Thus, the life for scribing of the cutting edge becomes longer.

FIG. 4 shows a front view and a side view of a chip holder 1 for cutting a brittle material. At the lower portion of the chip holder, two holder members 1a and 1b are provided in parallel, and they support a chip 2 between them roratably with bearings not shown. The chip holder 1 has an integral body including the holder members 1a and 1b, and a cutter chip 2 is fitted to the lower portion of the integral body to construct a chip holder 1. After binding the holder members 1a and 1b with a predetermined gap between them to hold the cutter chip 2 rotatably, the chip holder 1 can be used for a desired use.

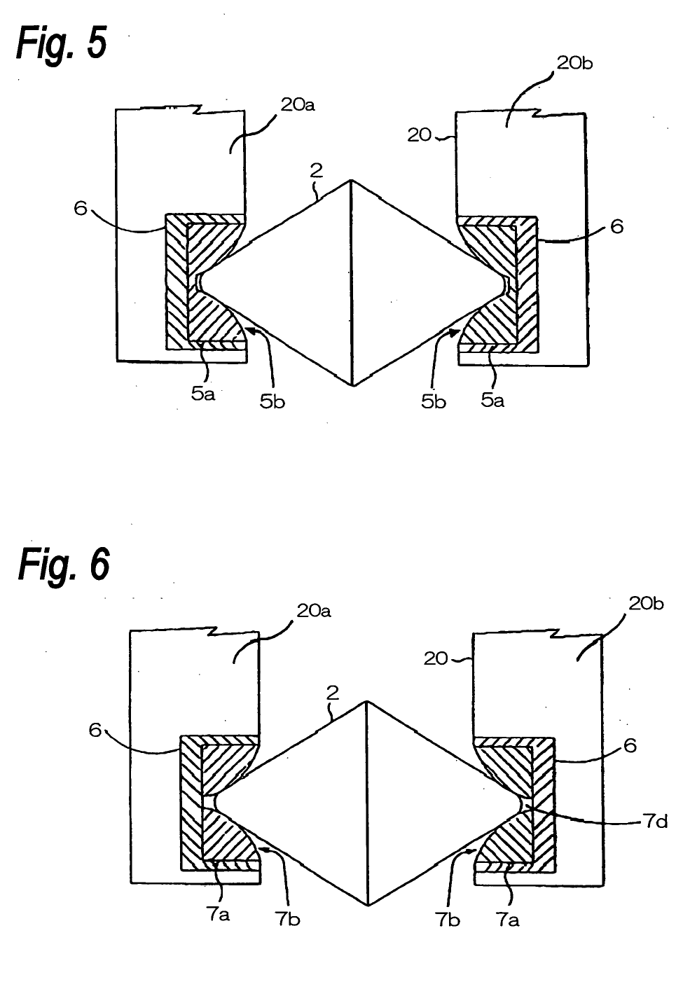

FIG. 5 shows a section of a chip holder 20 of a lower portion thereof. Bearing supporters 6 are fixed, for example, with soldering into circular recess provided in planes of the first holder member 20a and the second one 20b facing to each other. The bearing supporters 6 are made of, for example, Fe—Cu—Sn sintered metal, and it has been sintered with a bearing 5a made of monocrystalline diamond to have a cylindrical shape. The cutter chip 2 has a conical shaft at two sides of a circular ridge line of a cutting edge thereof. The supporting section 5b on the surface of the bearing 5a has a bell-like shape similar to the bell region shown in FIG. 3. For example, if the diameter of the circular ridge line of the cutting edge of the cutter chip 2 is 2 mm, the radius of curvature of the above-mentioned curve is about 0.2 to 2 mm. Further, if the radius of the cutting edge of the chip 2 is denoted as D in millimeter, the radius of curvature of the curve is selected in a range between 0.1D and D in millimeter.

The supporting section 5b forms a non-through recess, as shown in FIG. 5. That is, the recess of the supporting section 5b is not through to the bearing 5a. In this case, solid lubricant is supplied from the side of the cutter chip 2. The solid lubricant is, for example, tungsten disulfide or molybdenum disulfide having characteristics, for example, that it can be used in a wide temperature range and that it is hard to be vaporized.

FIG. 6 shows a chip holder 20 in a lower portion according to a second embodiment of the invention. Similarly to the lower portion of the chip holder of the first embodiment, bearing supporters 6 and bearings 7a are fixed into circular recess provided in planes of a first holder member 20a and a second one 20b facing to each other. The supporting section 7b has a throughhole 7d, and it is closed by the bearing supporter 6.

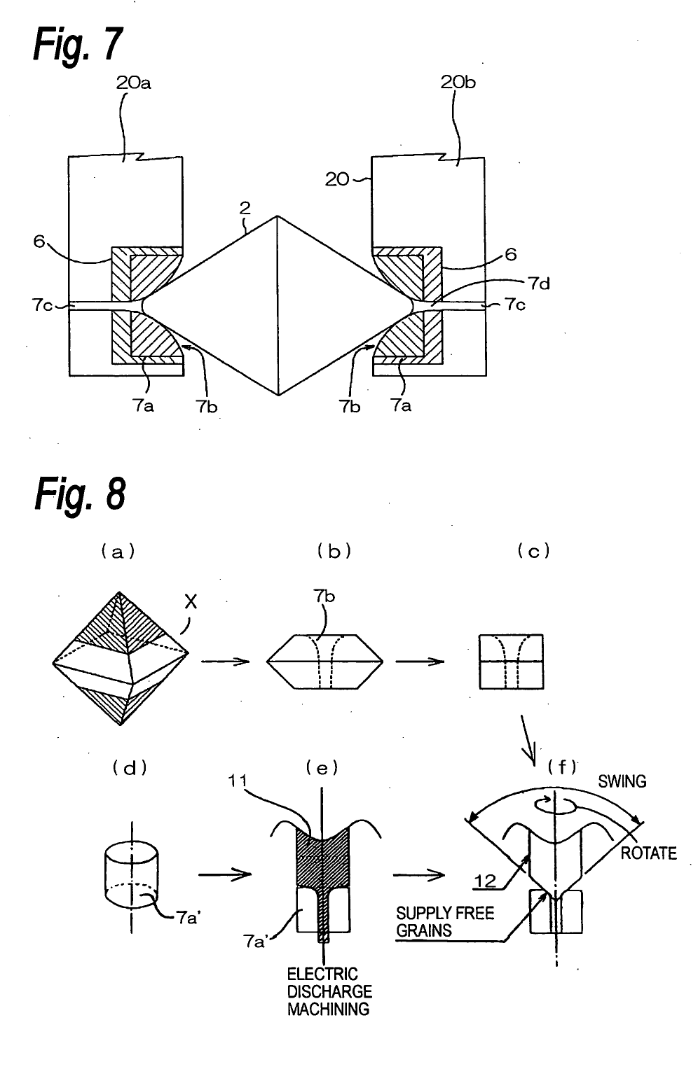

FIG. 7 shows a chip holder 20 in a lower portion according to a third embodiment of the invention. Similarly to the lower portion of the chip holder of the second embodiment, bearing supporters 6 and bearings 7a are fixed into circular recess provided in planes of a first holder member 20a and a second one 20b facing to each other. The supporting section 7b has a throughhole 7d, while a throughhole 7c is also formed through the bearing supporter 6 and the holder member 20a, 20b so as to align with the throughhole 7d. The throughholes 7c and 7d are used as an inlet to supply solid lubricant from the outside of the holder 20.

Further, in this case, the supporting section 7b has the circular ridge line of cutting edge with the radius of curvature of, for example, about 3 to 6 mm when the diameter of the cutting edge of the cutter chip 2 is 3 mm. Further, if the diameter of the cutting edge of the cutter chip 2 is denoted as D mm, the radius of curvature of the curve is selected in a range between D and 2D mm.

The chip holders according to the invention correspond to a structure wherein the two holder members 1a and 1b shown in FIG. 4 are replaced with the first and second holder members 20a and 20b according to one of the above-mentioned first to third embodiments.

FIG. 8 illustrates an embodiment of a fabrication process for a bearing 7a made of monocrystalline or sintered diamond. When the bearing 7a is made of monocrystalline diamond X, top and bottom parts of the diamond X, shown in (a) in FIG. 8A with hatching, is cut off with a skeif or the like, and a bell-shaped hole is formed at its center with a yttrium aluminum garnet (YAG) laser as a basis of the supporting section 7b ((b) in FIG. 8). Then the hole is rounded with a YAG laser to have a predetermined outer contour for the bearing 7a ((c) in FIG. 8). Then lapping is performed as shown in (f) in FIG. 8. In this step, while free grains (diamond grains of 2 to 4 μm) are supplied to the bearing supporter 7b, a needle 12 having the same tip angle as the bearing supporter 7b is rotated and swung further around the hole so as not to deform the bell shape.

When a bearing 7a made of sintered diamond is fabricated, diamond grains are first sintered to provide a cylindrical bearing 7a′ having a predetermined outer diameter ((d) in FIG. 8). Next, the cylindrical bearing 7a′ is subjected to electric discharge machining by using a discharge electrode 11 having a contour similar to the bell shape, and the bell shape is transferred to the cylindrical bearing 7a′ ((e) in FIG. 8). Then, while grains (diamond grains of 2 to 4 μm) are supplied to the surface subjected to the electric discharge machining, a needle 12 having the same tip angle as the bearing supporter 7b is rotated and inclined around the hole so as not to break the bell shape ((f) in FIG. 8).

The bearing 7a may be made of a gem such as sapphire or ruby. The lapping is not limited to the above-mentioned process, and for example, wire lapping may be used.

In order to fabricate a chip holder according to the invention, bearings 5a, 7a having the above-mentioned bell-shaped recess are held by the bearing holders 6 and mounted to the first and second holder members 20a and 20b. Next the cutter chip 2 is combined with the first and second holder members 20a and 20b having the bearings 5a, 7a.

Scribing tests are performed on the chip holders with edge load of 1.0 kg, and the running distance (or life) thereof is determined as a result of the endurance test. As to prior art chip holders shown in FIG. 2, the running distance is 150,000 meters on the average, while it is extended largely to 300,000 meters on the average for the chip holders of the invention. Further, by supplying solid lubricant every 10,000 meters, the life of the cutting edge is extended further by about 20 to 30%.

By using the bearing 5a, 7a impregnated with oil at the bearing supporter 5b, 7b, or so-called oiless bearing, for supporting the cutter chip 2, periodic refill for solid lubricant is not needed, and stable scribing performance can be kept. Alternatively, the bearing supporter 5b, 7b may be coated for improving the surface property and for hardening the surface (for example, defric coating) in order to extend the life of the bearings 5a, 7a.

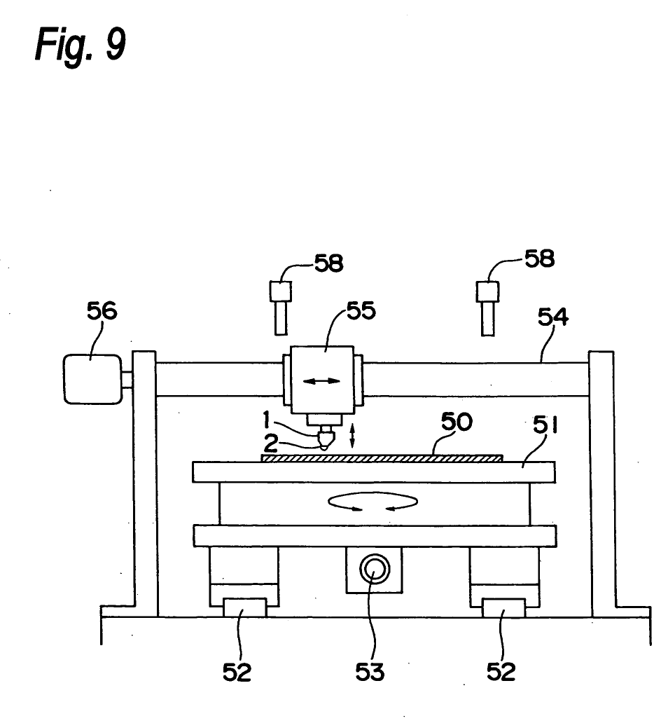

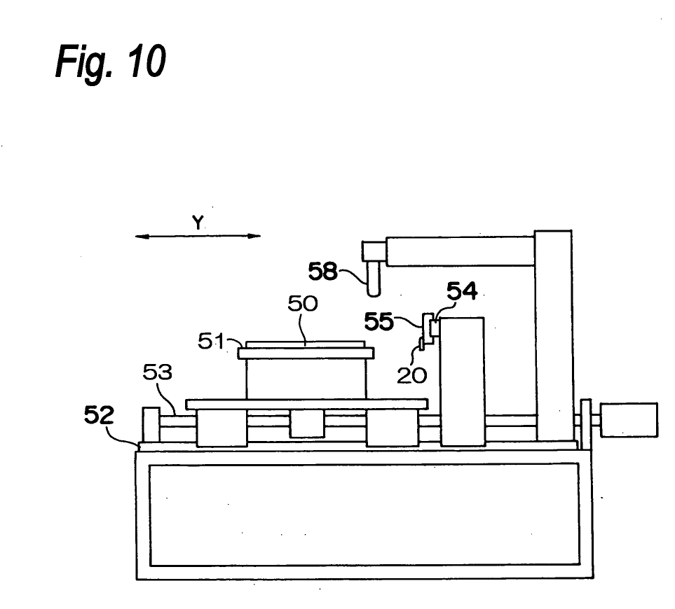

Next, a scribing apparatus is explained having the above-mentioned chip holder. FIGS. 9 and 10 are a front view and a side view of the scribing apparatus. A plate 50 made of a brittle material put on a horizontal rotatable table 51 is fixed on the table 51 by absorbing the plate with a vacuum pump (not shown), and a pair of parallel guide rails 52 support the table 51 and can guide it in Y direction (perpendicularly to the sheet of paper in FIG. 9) along the rails 52 with a ball screw 53. A guide bar 54 is provided above the table 51 in X direction (left-and-right direction in FIG. 9). A scribing head 55 is mounted on the guide bar 54 so as to slide in X direction, and a motor 56 is provided to slide the scribing head 55. The above-mentioned chip holder 20 is attached below the scribing head 55 so as to rise and fall and to swing around an axis perpendicular to the plat 50, and the cutter chip 2 is mounted rotatably at the lower end thereof. A pair of charge-coupled-device (CCD) cameras 58 are arranged above the guide bar 54 to recognize alignment marks provided on the plate 50 put on the table 51. Further, a cutter chip inverter is included in the scribing head 55 for inverting the direction of the chip holder 20 by 180 degrees so as to invert the cutter chip by 180 degrees each time a scribing line is formed.

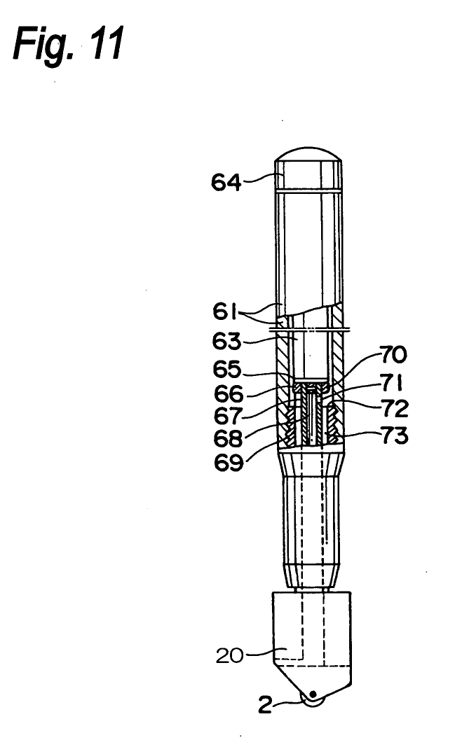

FIG. 11 shows a manual cutter having the above-mentioned chip holder. A cylindrical holder 61 for holding the manual cutter is the same as disclosed in Japanese Utility Model Publication 62-23780/1987 by the applicant, and the above-mentioned chip holder 20 is mounted on its bottom. The manual cutter can be used not only for a glass plate, but also for a plate made of a brittle material such as a ceramic or a semiconductor material. Further, the manual cutter includes an oil chamber 63, a cap 64 thereof and mechanisms 65-73 therefor, but they are not directly related to the invention, and explanation thereof is omitted here.

Although the present invention has been fully described in connection with the embodiments thereof with reference to the accompanying drawings, it is to be noted that the invention is not limited to these embodiments.

1. A chip holder comprising:
a cutter chip having a conical shaft at both sides of a circular ridge line of a cutting edge thereof;
two holders; and
two bearings for holding said cutter chip, provided at opposing sides of said two holders;
wherein each of said two bearings has a bell-shaped concave for supporting said cutter chip.

2. The chip holder according to claim 1, wherein said bell-shaped concave has a curved plane having a predetermined radius of curvature.

3. The chip holder according to claim 1, wherein said bell-shaped concave is not through to said holder.

4. The chip holder according to claim 2, wherein said bell-shaped concave is not through to said holder, and the radius of curvature is 0.1D to D wherein diameter of cutting edge of said cutter chip is represented as D.

5. The chip holder according to claim 1, wherein said bell-shaped concave is extended to said holder.

6. The chip holder according to claim 2, wherein said bell-shaped concave is extended to said holder, and the radius of curvature is D to 2D wherein diameter of cutting edge of said cutter chip is represented as D.

7. The chip holder according to claim 1, wherein said bearings are made of monocrystalline diamond.

8. The chip holder according to claim 1, wherein said bearings are made of sintered diamond.

9. A method for producing a chip holder having a cutter chip having a conical shaft at both sides of a circular ridge line of a cutting edge thereof, comprising the steps of:
forming a bell-shaped concave for a bearing for supporting the cutter chip;
mounting a bearing holder holding the bearing into each of first and second holder members; and
combining a cutter chip with the first and second holder members having the bearings.

10. The method according to claim 9, wherein said bearing is made of monocrystalline diamond.

11. The method according to claim 10, wherein said concave with the bell shape is fabricated with a YAG laser.

12. The method according to claim 9, wherein said bearing is made of sintered diamond.

13. The method according to claim 12, wherein the bell-shaped recess is formed with electric discharging machining.

14. A scriber apparatus comprising a mechanism for moving a scribing head in X and/or Y direction relatively to a table on which a plate made of a brittle material is put, wherein said scribing head comprises a chip holder according to claim 1.

15. A manual cutter comprising:
a cylindrical grip; and a chip holder fixed to an end of said grip, wherein said chip holder is one of the chip holders according to claim 1.

16. The chip holder according to claim 2, wherein said bell-shaped concave is not through to said holder.

17. The chip holder according to claim 2, wherein said bell-shaped concave is extended to said holder.

18. The chip holder according to claim 2, wherein said bearings are made of monocrystalline diamond.

19. The chip holder according to claim 3, wherein said bearings are made of monocrystalline diamond.

20. The chip holder according to claim 4, wherein said bearings are made of monocrystalline diamond.

21. The chip holder according to claim 5, wherein said bearings are made of monocrystalline diamond.

22. The chip holder according to claim 6, wherein said bearings are made of monocrystalline diamond.

23. The chip holder according to claim 2, wherein said bearings are made of sintered diamond.

24. The chip holder according to claim 3, wherein said bearings are made of sintered diamond.

25. The chip holder according to claim 4, wherein said bearings are made of sintered diamond.

26. The chip holder according to claim 5, wherein said bearings are made of sintered diamond.

27. The chip holder according to claim 6, wherein said bearings are made of sintered diamond.

28. A scriber apparatus comprising a mechanism for moving a scribing head in X and/or Y direction relatively to a table on which a plate made of a brittle material is put, wherein said scribing head comprises a chip holder according to claim 2.

29. A scriber apparatus comprising a mechanism for moving a scribing head in X and/or Y direction relatively to a table on which a plate made of a brittle material is put, wherein said scribing head comprises a chip holder according to claim 3.

30. A scriber apparatus comprising a mechanism for moving a scribing head in X and/or Y direction relatively to a table on which a plate made of a brittle material is put, wherein said scribing head comprises a chip holder according to claim 4.

31. A scriber apparatus comprising a mechanism for moving a scribing head in X and/or Y direction relatively to a table on which a plate made of a brittle material is put, wherein said scribing head comprises a chip holder according to claim 5.

32. A scriber apparatus comprising a mechanism for moving a scribing head in X and/or Y direction relatively to a table on which a plate made of a brittle material is put, wherein said scribing head comprises a chip holder according to claim 6.

33. A scriber apparatus comprising a mechanism for moving a scribing head in X and/or Y direction relatively to a table on which a plate made of a brittle material is put, wherein said scribing head comprises a chip holder according to claim 7.

34. A scriber apparatus comprising a mechanism for moving a scribing head in X and/or Y direction relatively to a table on which a plate made of a brittle material is put, wherein said scribing head comprises a chip holder according to claim 8.

35. A manual cutter comprising:
a cylindrical grip; and a chip holder fixed to an end of said grip, wherein said chip holder is one of the chip holders according to claim 2.

36. A manual cutter comprising:
a cylindrical grip; and a chip holder fixed to an end of said grip, wherein said chip holder is one of the chip holders according to claim 3.

37. A manual cutter comprising:
a cylindrical grip; and a chip holder fixed to an end of said grip, wherein said chip holder is one of the chip holders according to claim 4.

38. A manual cutter comprising:
a cylindrical grip; and a chip holder fixed to an end of said grip, wherein said chip holder is one of the chip holders according to claim 5.

39. A manual cutter comprising:
a cylindrical grip; and a chip holder fixed to an end of said grip, wherein said chip holder is one of the chip holders according to claim 6.

40. A manual cutter comprising:
a cylindrical grip; and a chip holder fixed to an end of said grip, wherein said chip holder is one of the chip holders according to claim 7.

41. A manual cutter comprising:
a cylindrical grip; and a chip holder fixed to an end of said grip, wherein said chip holder is one of the chip holders according to claim 8.
